(19) United States
(12) Patent Application Publication
(10) Pub. No.: US 2019/0358577 A1
(43) Pub. Date: Nov. 28, 2019

(54) Odor and Volatile Organic Chemical Control Assembly Activated by Use

(71) Applicant: Ronald F. Twining, Dripping Springs, TX (US)

(72) Inventor: Ronald F. Twining, Dripping Springs, TX (US)

(21) Appl. No.: 16/444,441

(22) Filed: Jun. 18, 2019

Related U.S. Application Data
(60) Provisional application No. 62/672,830, filed on May 17, 2018.

(51) Int. Cl. B01D 53/04; B32B 5/02; B32B 5/18; B32B 5/26; B32B 5/24; A47C 31/00; A47C 27/00

(52) U.S. Cl. CPC B01D 53/0446; A01K 1/0353; B32B 5/18; B32B 5/26; B32B 5/245; A47C 31/007; A47C 27/007; B01D 2253/102; B01D 2253/108; B01D 2257/708; B01D 2257/90; B32B 2307/724; B32B 2307/758; B32B 2479/00; B32B 5/02

(57) ABSTRACT

An odor and volatile organic chemical (VOC) control cushion or mat assembly in which air flow through the assembly is generated by the use thereof, which use depresses and expands the structure of the assembly.

### BACKGROUND

### Field of Invention

An odor and volatile organic chemical (VOC) control cushion or mat assembly in which air flow through the assembly is generated by the use thereof, which use depresses and expands the structure of the assembly.

### Background

There is a need for cushions and mats that control odor and that adsorb VOC. While there are many such cushions and mats commercially available, they do not generally provide a means to generate airflow through an odor control material and depend on static adsorption from odor containing air. Thus, the effectiveness is much less than would be possible if the odor or VOC containing air is forced to flow through the odor and VOC adsorbing material.

Both odors and VOC are objectionable in a home setting. Animal odors can be offensive and Volatile organic chemicals (VOC) can be objectionable and hazardous. According to the EPA (U.S R Environmental Protection agency) VOC's are:

“Volatile organic compounds (VOCs) are emitted as gases from certain solids or liquids. VOCs include a variety of chemicals, some of which may have short- and long-term adverse health effects. Concentrations of many VOCs are consistently higher indoors (up to ten times higher) than outdoors. VOCs are emitted by a wide array of products numbering in the thousands. Organic chemicals are widely used as ingredients in household products. Paints, varnishes and wax all contain organic solvents, as do many cleaning, disinfecting, cosmetic, degreasing and hobby products. Fuels are made up of organic chemicals. All of these products can release organic compounds while you are using them, and, to some degree, when they are stored. EPA's Office of Research and Development's “Total Exposure Assessment Methodology (TEAM) Study” (Volumes I through IV, completed in 1985) found levels of about a dozen common organic pollutants to be 2 to 5 times higher inside homes than outside, regardless of whether the homes were located in rural or highly industrial areas. TEAM studies indicated that while people are using products containing organic chemicals, they can expose themselves and others to very high pollutant levels, and elevated concentrations can persist in the air long after the activity is completed.”

“Volatile organic compounds (VOC) means any compound of carbon, excluding carbon monoxide, carbon dioxide, carbonic acid, metallic carbides or carbonates and ammonium carbonate, which participates in atmospheric photochemical reactions, except those designated by EPA as having negligible photochemical reactivity. Volatile organic compounds, or VOCs are organic chemical compounds whose composition makes it possible for them to evaporate under normal indoor atmospheric conditions of temperature and pressure. This general definition of VOCs is used in the scientific literature, and is consistent with the definition used for indoor air quality. Since the volatility of a compound is generally higher the lower its boiling point temperature, the volatility of organic compounds are sometimes defined and classified by their boiling points. For example, the European Union uses the boiling point, rather than its volatility in its definition of VOCs. A VOC is any organic compound having an initial boiling point less than or equal to 250° C. measured at a standard atmospheric pressure of 101.3 kPa”. “https://www.epa.gov/indoor-air-quality-iaq/volatile-organic-compounds-impact-indoor-air-quality.

The present invention is such an assembly that provides airflow through odor and VOC adsorbing material.

### SUMMARY

The invention is a cushion or mat assembly that is constructed in a way to force air to be passed through it by its use. The assembly is constructed of several different internal layers and external construction such that air is directed through an internal layer or layers which contains an odor absorbing medium. The internal odor absorbing layer thereby absorbs odors and VOC by a kind of bellows action that causes air to move across the odor absorbing medium, such as when a person sits on the cushion, or an animal sits or lays on it. In addition to the active bellows action airflow, temperature difference conductive, or other passive airflow will also cause air to move across the odor absorbing medium.

### DESCRIPTION OF THE DRAWINGS

Reference is made to the drawings, in which the same reference numbers are used throughout to designate the same components.

FIG. 1 is a prospective view of a cushion or mat assembly of an embodiment of the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION

In broad aspect the odor and VOC control cushion or mat assembly of the present invention comprises, in some embodiments, an assembly of layers and side pieces, Specifically, an odor and VOC control assembly comprising:
a) an air permeable top panel,
b) an air permeable odor and VOC adsorption layer,
c) an air permeable stabilizing layer; a cushioning bottom layer,
d) side panels that allow air flow and side panels that block air flow, and
   wherein, the panels and layers are selected and assembled in such a way as to provide support and comfort to a user and to promote a bellows action causing air to move across the odor and VOC absorbing layer as well as to not impede conductive, or passive airflow.
   The assembly may be constructed as a mat or cushion or other suitable structure. It may be encased in an air permeable fabric envelope. Odor and VOC adsorbing materials are those known to adsorb odors and/or VOC such as activated charcoal and zeolites.

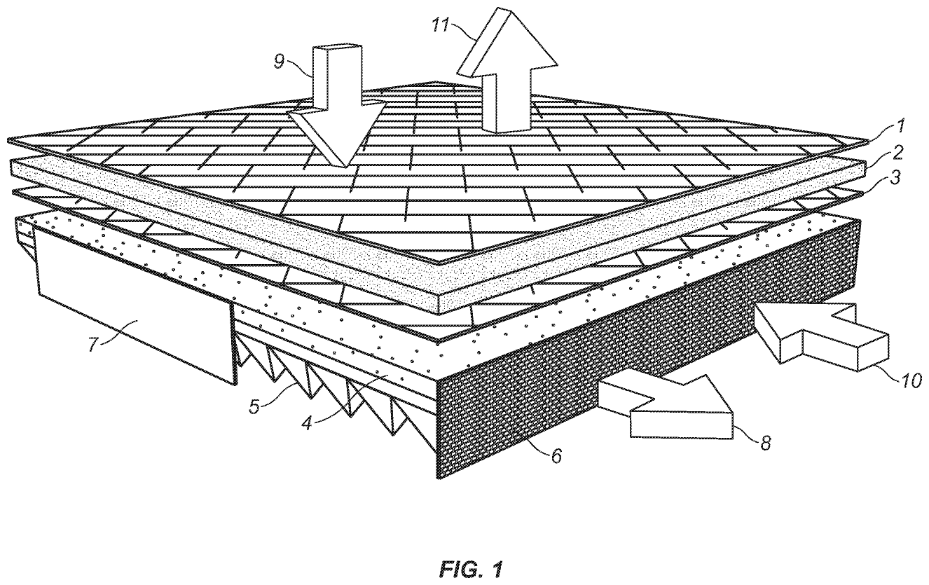

An embodiment of the odor and VOC control assembly of this invention is illustrated in FIG. 1. Referring to FIG. 1, there is shown a top layer, 1, that allows air flow through (“breathable”). It may be made of any suitable mesh or air permeable material, preferably a fabric that has sufficient strength to support the assembly and to withstand repeated use. It may be quilted to aid in maintaining its structural integrity. Below the top layer, 1, is an odor and VOC control adsorption layer, 2. This layer or layers will contain charcoal or zeolite (known to adsorb odors and VOC) infused into foam or fabric mat or other suitable material or structure that will adsorb and contain the odor and VOC adsorbing materials. By infused is meant disposing the odor and VOC adsorbing material in the containing mat by any known means as, for example, loose activated charcoal or other odor and VOC adsorbing material sandwiched between layers of breathable medium, which could be in a variety of forms and accomplished by a variety of means. Thus, the odor and VOC absorbing medium, whether activated charcoal or some other material such as zeolite, could be attached, infused, adhered to or bonded in a plurality of ways to various places in the path of the air movement in the assembly design and still function as intended. While the figure illustrates one layer the odor and VOC absorbing material the material may be disposed in multiple layers placed in the same or different locations in the assembly. The odor and VOC adsorbing layer may also be disposed above or below the cushioning layer described below. There may also be an optional stabilizing layer or panel disposed beneath the odor and VOC adsorbing panel. The arrangement may be varied to achieve different effects or to address different functional objectives. This layer or layers must allow for air flow through it, (breathable or air permeable). Layer 2 may be separate from layer 1, or layer 1 may be integral with it. For example, this layer maybe designed in such a way as to be removable, such as a zippered panel covering or enclosure.

The assembly may be shaped as a square or rectangle, circular, or oval. Any shape is suitable so long as the side sections of the assembly, as described below, are attachable. Optional layer 3 is much like layer 1 and is used to stabilize and contain the odor and VOC adsorbing layer 2. Like the top layer, it may be quilted and made of any suitable material that will allow air to pass through and may be separate or integral with layer 2.

Layer 4 is a cushioning layer such as an air permeable memory foam or similar material. It may be any material that provides a cushioning function and air flow (air permeability). Its primary purpose is to provide comfort. It can be a replaceable layer and can be of varying cushioning firmness so that the firmness or comfort level can be tailored for each specific use. Multiple layer of cushioning material may be used.

Some of the side(s) of the assembly may be sealed or covered with an air permeable covering. To minimize air movement through the assembly “leaking out” in inefficient areas, and maximize the bellows action movement of air, sides of the assembly may be sealed in such a way as to channel the air through only certain portions of the assembly channeling the flow of air going to and from the odor and VOC absorbing area. Blocking by covering or sealing may be accomplished by applying a non-breathable layer or coating, such as, for example, a rubberized coating. Tape or other membranes or painted on sealer are also suitable ways of achieving this sealing effect. One or more sides of the layered assembly will have a breathable covering, such as 6, that is, one that allows air flow. One or more layers, such as layer 7, is made of a material that blocks air flow.

By blocking air flow from one or more sides and allowing air flow from other sides provides a “bellows” effect the pushes air through the assembly as is illustrated by the air flow arrows 8, 9, 10 and 11. A removable layer is preferable in some cases where it is desirable to easily remove and replace or change a layer of the assembly. Thus, when pressure is applied and released on the top of the assembly air is “pumped” through the assembly and odor and VOC adsorbed by the odor adsorbing layer 2. For example, pressure is applied and released as when someone or an animal sits or lays on the mat assembly or changes position. Thus, the assembly odor and VOC control is activated by use.

Layer 5, the bottom layer, provides support for the assembly. It consists of be an air permeable material that provides support for the assembly and allowed for excellent airflow. One such material that is suitable is convoluted acoustical foam with the convoluted side facing downward. The primary purpose of this layer is to allow air to freely move through it. It can also be made of other breathable material, preferably with a configuration that allows open spaces on its bottom surface allowing it to be placed on a solid surface with openings to allow air flow. It may alternatively be sealed (as explained below) and have a flat bottom section when it is desired that there be no air flow through the bottom of the assembly.

It is frequently expedient to provide the assembly described above as a kit. This allows for sale of the assembly structure and later replacement odor and VOC adsorbing panel or layers. It also allows the odor adsorbing layer to be customized as to odor adsorbing components, structure and efficiency. Thus, the invention is in one embodiment a kit comprising;
a) an structure containing an odor and VOC adsorbing material,
b) a structure capable of accepting the structure of a) comprising,
a) an air permeable top layer,
b) a air permeable stabilizing layer,
c) a cushioning bottom layer,
d) side layers that allow air flow and side panels that block air flow,
   and wherein the structures a) and b) are configured to allow structure a) to be replaceable in structure b) in a manner to form a seat, mat or cushion.

Although the invention hereof has been described by way of specific embodiments, it will be evident that other adaptations and modifications can be employed without departing from the spirit and scope thereof. The terms and expressions employed herein have been used as terms of description and not of limitation; and thus, there is no intent of excluding equivalents, but on the contrary, it is intended to cover all equivalents that may be employed without departing from the spirit and scope of the invention.

1. An odor and volatile organic chemical control assembly comprising;
a) an air permeable top panel,
b) an air permeable odor and volatile organic chemical adsorption layer,
d) a cushioning bottom layer,
e) a bottom panel,
f) side panels that allow air flow and side panels that block air flow, and
wherein the panels and layers are selected and assembled in such a way as to provide support, comfort to a user and to promote a bellows action causing air to move across the odor an volatile organic chemical absorbing layer as well as to not impede conductive, or passive airflow.

2. The assembly of claim 1 wherein the odor and volatile organic chemical adsorbing layer comprises charcoal or zeolite.

3. The assembly of claim 1 wherein the layers are reversibly removable and replaceable in the assembly.

4. The assembly of claim 1 wherein the assembly is configured as a seat, mat, cushion or animal bed.

5. The assembly of claim 1 wherein the bottom panel blocks air flow.

6. The assembly of claim 1 wherein the assembly comprises multiple odor adsorption layers.

7. The assembly of claim 1 wherein the assembly the odor and volatile organic chemical adsorption layer is charcoal or zeolite infused foam.

8. The assembly of claim 1 wherein the assembly is encased in an air permeable envelope.

9. A stacked odor and volatile organic chemical adsorbing mat comprising;
a) a first air permeable top layer,
b) a second air permeable odor and volatile organic chemical adsorption layer,
c) a cushioning bottom layer, and
d) side layers that allow air flow and side panels that block air flow.

10. The stacked odor and volatile organic chemical adsorbing mat of claim 9 wherein the odor and volatile organic chemical adsorbing layer comprises charcoal or zeolite and the layers are reversibly removable and replaceable.

11. A kit comprising;
a) an structure containing an odor and volatile organic chemical adsorbing material,
b) a structure capable of accepting the structure of a) comprising,
1) a first air permeable top layer,
2) a cushioning bottom layer,
3) side layers that allow air flow and side panels that block air flow, and
wherein the structures a) and b) are configures to allow structure a) to be replaceable in structure b) in a manner to form a seat, mat or cushion.

12. The kit of claim 11 wherein the odor and volatile organic chemical adsorbing layer comprises charcoal or zeolite.
